(19) United States
(12) Patent Application Publication
(10) Pub. No.: US 2025/0105483 A1
(43) Pub. Date: Mar. 27, 2025

(54) DUPLEX CERAMIC FILTER

(71) Applicant: CACI, INC.- FEDERAL, Reston, VA (US)

(72) Inventor: Scott W. BURGESS, Albuquerque, NM (US)

(21) Appl. No.: 18/472,438

(22) Filed: Sep. 22, 2023

(51) Int. Cl. H01P 1/208; H01P 1/161; H01Q 5/20

(52) U.S. Cl. CPC H01P 1/208; H01P 1/161; H01Q 5/20

(57) ABSTRACT

E-plane waveguide duplexers comprising two filters (e.g., one or more E-plane ceramic waveguide filters), and methods for manufacturing the same, are described herein. The duplexer may include a plurality of septa (including a first septum and a second septum) formed by a union of a first dielectric block and a second dielectric block (e.g., ceramic). The first septum and/or the second septum may limit a residual field strength from the loop (e.g., inductive loop) to couple small amounts of energy from the first filter to the second filter (e.g., creating the duplexer). The width of the first septum and/or the second septum may determine the input loading from a first channel of the duplexer to a second channel of the duplexer. Moreover, by reducing the part count of the duplexer and/or decreasing its complexity, the structure of the duplexer may be manufactured more efficiently and its cost may be decreased.

### FIELD

The present disclosure is generally related to ceramic filters, and more particularly, to structures of a duplex filter comprising two separate filters.

### BACKGROUND

Filters are electronic devices that allow for the transmission of electromagnetic waves. Filters are typically designed so as to permit at one or more frequencies to pass through the filter, and to substantially prevent other frequencies from passing through the filter.

In an example, a base station for a mobile communication system and microwave radio links used for data transport may include a plurality of transceivers connected to an antenna for transmitting and receiving microwave signals. Each transceiver may include a diplexer/duplexer comprising of at least two band-pass filters. The filters of the diplexer may have different passbands, e.g., to prevent intermodulation between a transmission signal and a received signal.

Microwave filters (e.g., transmission line filters) often include a microstrip arranged on a dielectric carrier. Hollow waveguides are also often used as filters due to, as compared to microstrip filter, lower associated losses and higher associated power capabilities. However, hollow waveguide filters often have larger surface areas than microstrip filters.

Ceramic waveguide filters are particularly beneficial hollow waveguide filter types due to their small size and weight. Ceramic waveguide filters can include a block of ceramic having high permittivity and low loss characteristics, with a design to achieve particular frequency attenuation and propagation.

The dimensions of a hollow waveguide filter are dependent on one or more of a frequency of the signal to be filtered, selected filtering properties (e.g., a certain passband), and type of filter. Since the size of the waveguide must be on the same order as the wavelength of the frequency of the signal that is to be filtered, hollow waveguides are typically used for frequencies in the GHz range which have wavelengths in the mm range.

In some applications, such as in outdoor microwave radio or radio base station units, selecting a type of filter may be dependent on one or more of size limitations and/or available space. Thus it is often desirable to reduce the size of a filter without degrading frequency properties of the filter. E-plane filters may be an attractive choice due to footprint size and ease of production.

Conventional E-plane filters are typically designed with a metallic septum (e.g., conductive foil or insert) sandwiched between one or more air cavities. The septum may be arranged in the waveguide filter at or close to the location where the strength of the E-field (V/m) is the highest. The septum may include periodic windows (e.g., apertures) which act as resonators, thereby determining the poles of the filter, and consequently also contribute to determining the passband of the filter. In some E-filter designs, rather than utilizing a metal septum, the septum and window structures are etched on a circuit board. E-plane filters of this type require at least 3 parts to manufacture, e.g., two housings and one septum. Moreover, E-plane filters of this type may be costly and complex to manufacture.

Increasing in cost and complexity, a duplexer is a three port filtering device which allows transmitters and receivers operating at different frequencies to share the same antenna. Often, it is desirable to connect two frequency bands together in duplex, e.g., providing one common port and a transmit and receive frequency band. Thus, a duplexer typically consists of two band pass filters connected in parallel. Accordingly, the complexity of a duplexer utilizing conventional E-plane filters is further increased by utilizing more than one conventional E-plane filter.

In order to simplify the structure of the duplexer and decrease its cost, there is a need to reduce the part count of the duplexer and decrease the complexity of the duplexer.

### SUMMARY

The foregoing needs are met, to a great extent, by the disclosure directed to a duplexer comprising two filters (e.g., including one or more ceramic waveguide filters). Duplexers and methods for manufacturing the same are described herein. The architecture may include a plurality of septa formed by a union of a first dielectric (e.g., ceramic) block and a second dielectric (e.g., ceramic) block. The plurality of septa may include a first septum and a second septum.

The first dielectric block may include a first coupling structure and the second dielectric block may include a second coupling structure. The plurality of septa may be formed by the union of the first coupling structure and the second coupling structure. For example, the first dielectric block may include a first longitudinal surface comprising the first coupling structure, a second longitudinal surface, and a top surface. The second dielectric block may include a first longitudinal surface comprising the second coupling structure, a second longitudinal surface, and a top surface, and may be coupled to the first dielectric block via respective first longitudinal surfaces. Moreover, the first coupling structure may include a metallic coating disposed along an exterior of the first dielectric block and the second coupling structure may include a metallic coating disposed along an exterior of the second dielectric block.

A plurality of windows may be defined by the first dielectric block and the second dielectric block. A first window of the plurality of windows may be further defined by the first septum and the second septum. Moreover, the first dielectric block and/or the second dielectric block may comprise a four-pole filter.

In some aspects, a loop in communication with the first window and configured to transmit energy from a first port to the first window. For example, the energy may be a radio frequency (RF) signal. The loop may be an inductive loop and may provide coupling between the filters of the duplexer.

A second port of the duplexer may be configured to receive (e.g., based on a width of the septa) the transmitted energy at a first distal end of the waveguide duplexer. A third port of the duplexer may be configured to receive (e.g., based on the width of the septa) the transmitted energy at a second distal end of the duplexer (e.g., a waveguide duplexer).

According to some aspects, a width of the first septum may be equal to a width of the second septum. In some other aspects, a width of the first septum may be different from a width of the second septum. The first septum and/or the second septum may limit a residual field strength from the loop (e.g., inductive loop) to couple small amounts of energy from the first filter to the second filter (e.g., creating the duplexer). The width of the first septum and/or the second septum may determine the input loading from a first channel of the duplexer to a second channel of the duplexer.

According to some aspects, the present disclosure may provide a method of minimizing return loss of a transmission of an RF signal. An RF signal may be received by a waveguide duplexer. The waveguide duplexer may include a plurality of septa formed by a union of a first dielectric block (e.g., including a 4-pole filter) and a second dielectric block (e.g., including a 4-pole filter). The plurality of septa may include a first septum and a second septum. Moreover, a plurality of windows may be defined by the first dielectric block and the second dielectric block. For example, a first window of the plurality of windows may be further defined by the first septum and the second septum.

The RF signal may be transmitted by a loop from a first port to the first window. For example, the loop may be an inductive loop in communication with the first window. The transmitted RF signal may be received at a first distal end of the waveguide duplexer. For example, the transmitted RF signal may be received at a second port based on a width of the septa. A returned RF signal may be received at a second distal end of the duplexer. For example, the returned RF signal may be received at a third port based on the width of the septa.

According to some aspects, a frequency of the transmitted RF signal may be greater than a minimum transmission frequency (e.g., 1600 MHZ) and less than a maximum transmission frequency (e.g., 2000 MHz).

According to some aspects, the present disclosure may provide a communication system. The communication system may include a printed circuit board comprising one or more of input pads, first output pads, and second output pads. Moreover, the communication system may include a waveguide duplexer.

The waveguide duplexer may include a plurality of septa formed by a union of a first dielectric block and a second dielectric block. The plurality of septa may include a first septum and a second septum. Moreover, the plurality of septa may include a plurality of windows defined by the first dielectric block and the second dielectric block. The first window of the plurality of windows may be further defined by the first septum and the second septum.

Furthermore, the waveguide duplexer may include an inductive loop configured to transmit energy from the input pads to the first window. The first output pads may be configured to receive the transmitted energy at a first distal end of the duplexer. For example, the transmitted energy may be received at the first distal end of the duplexer based on a width of the septa. The second output pads may be configured to receive the transmitted energy at a second distal end of the duplexer. For example, the transmitted energy at the second distal end of the duplexer may be received based on the width of the septa. According to some aspects, a width of the first septum is equal to a width of the second septum. In some other aspects, a width of the first septum may be different from a width of the second septum.

There has thus been outlined, rather broadly, certain aspects in order that the detailed description thereof herein may be better understood, and in order that the present contribution to the art may be appreciated. There are, of course, additional aspects that the disclosure provided herein will describe below and which will for the subject matter of the claims hereto.

### BRIEF DESCRIPTION OF THE DRAWINGS

In order to facilitate a fuller understanding of the disclosure, reference is now made to the accompanying drawings, in which like elements are referenced with like numerals. These drawings should not be construed as limiting the disclosure and are intended only to be illustrative.

FIG. 1 illustrates a filter according to the present disclosure.

FIG. 2 illustrates a duplexer according to the present disclosure.

FIG. 3 illustrates a frequency response graph for a duplexer according to the present disclosure.

FIG. 4 illustrates a filter according to the present disclosure.

FIG. 5 illustrates a filter according to the present disclosure.

FIG. 6A illustrates a frequency response graph for a duplexer according to the present disclosure.

FIG. 6B illustrates a graph representation for a duplexer according to the present disclosure.

FIG. 7 depicts a process for assembling a duplexer according to the present disclosure.

FIG. 8 depicts a process for minimizing return loss of a transmission of an RF signal according to the present disclosure.

### DETAILED DESCRIPTION

In this respect, before explaining at least one embodiment in detail, it is to be understood that the disclosure is not limited in its application to the details of construction and to the arrangements of the components set forth in the following description or illustrated in the drawings. The invention is capable of embodiments or embodiments in addition to those described and of being practiced and carried out in various ways. Also, it is to be understood that the phraseology and terminology employed herein, as well as the abstract, are for the purpose of description and should not be regarded as limiting.

Reference in this application to “one embodiment,” “an embodiment,” “one or more embodiments,” or the like means that a particular feature, structure, or characteristic described in connection with the embodiment is included in at least one embodiment of the disclosure. The appearances of, for example, the phrases “an embodiment” in various places in the specification are not necessarily all referring to the same embodiment, nor are separate or alternative embodiments mutually exclusive of other embodiments. Moreover, various features are described which may be exhibited by some embodiments and not by the other. Similarly, various requirements are described which may be requirements for some embodiments but not by other embodiments.

Waveguide filters, waveguide duplexers/diplexers, and associated methods are described herein. In some cases, a structure of a ceramic filter may include one or more resonators and one or more coupling windows. The structure may include two coupled metalized dielectric blocks. Coupling structures may be pressed, machined, lased, or screen printed onto or into each of the metallized dielectric blocks. A waveguide filter may be formed by attaching the coupling structures to each other. Moreover, one or more of resonators, a metalized septum for inter-resonator couplings, and/or various input and output couplings loops or probes for input loading into the filter may be pressed, machined, lased, or screen printed onto\into the blocks, e.g., eliminating the need for a separate septum. By reducing the part count of the filter and/or decreasing its complexity, the structure of the filter may be manufactured for efficiently and its cost may be decreased.

According to some aspects, an E-plane waveguide filter may be divided in half (e.g., along a narrow wall of the E-plane waveguide filter) into ceramic blocks (e.g., two rectangular shaped blocks). The ceramic blocks may be connected or assembled to create the E-plane waveguide filter. The ceramic blocks may be coupled through an inductive window (e.g., of varying shapes and sizes) on the narrow wall.

According to some aspects, each of the ceramic blocks may be plated. A pattern (e.g., pattern artwork) may be created (e.g., by lasing or screen printing) on one or more of the blocks. The pattern may simultaneously create one or more of resonators, metalized septum for inter-resonator couplings, and various input and output couplings loops or probes for the input loading into the filter. For example, a pattern artwork may couple the electric field through the filter's resonators (e.g., created by periodic open windows). Metalized septa between the windows may create inductive couplings between each resonator pair. Moreover, a loop or probe input coupling may be incorporated into the pattern artwork to create either capacitive or inductive input and output couplings (e.g., loading) into the filter.

According to some aspects, two separate filters may be duplexed to create a 3-port device by connecting two frequency bands together in duplex (e.g., a duplexer/diplexer). The resulting duplexer/diplexer may have one common port and a transmit and receive frequency band. According to some aspects, a technique for duplexing two separate filters into a duplexer/diplexer may include coupling the two separate filters by an inductive loop. A septum may limit residual field strength from the inductive loop to couple small amounts of energy from a first filter to a second filter (e.g., thereby creating a duplexer/diplexer). The width of the septum to the second filter may determine an input loading to a second channel of the duplexer/diplexer.

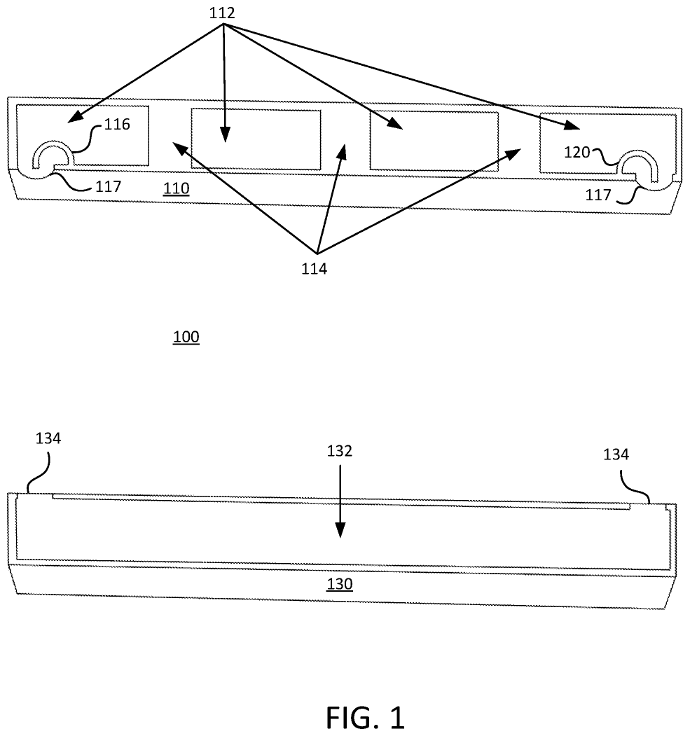

FIG. 1 depicts a filter 100 according to the present disclosure. For example, the filter 100 may be an E-plane waveguide filter. The filter 100 may include a first dielectric block 110 (e.g., a ceramic block). The first dielectric block 110 may define one or more of length, width, and thickness dimensions. Moreover, the filter 100 may be comprised of a plurality of dielectric blocks. For example, the filter 100 may include a second dielectric block 130 (e.g., a ceramic block). The second dielectric block 130 may define one or more of length, width, and thickness dimensions. In some cases, the first dielectric block 110 and/or the second dielectric block 130 may be coated with a metallic substance (e.g., formed on an outer surface).

The first dielectric block 110 may be coupled to the second dielectric block 130 along respective longitudinal surfaces of the first dielectric block 110 and the second dielectric block 130. A surface of each block (e.g., first dielectric block 110 and/or second dielectric block 130) may comprise a metallic coating. For example, the first dielectric block 110 and/or second dielectric block 130 may be coated with a metallic substance prior to coupling to the other blocks of the filter 100.

One or more surfaces of the blocks (e.g., first dielectric block 110 and/or second dielectric block 130) of the filter 100 may be etched to form various structures contained in the filter 100. Patterns may be printed on one or more adjoining block surfaces to create various structures (e.g., resonator windows, inductive windows, etc.) of the filter 100.

For example, first dielectric block 110 may include a plurality (e.g., four) of resonator windows 112. For example, a surface of a block may be etched to form one or more resonator windows 112 (e.g., between adjacent blocks). The one or more resonator windows 112 may expose a dielectric material within a block.

The resonator windows 112 may be separated (e.g., in the height dimension) by inter-resonator coupling septum or septa 114. Each inter-resonator coupling septum 114 may span the height of the window, and may run substantially parallel to a height dimension of a block. Each inter-resonator coupling septum 114 may be slightly different in width depending on how much energy needs to couple between each resonator pair to create a desired filter response.

A first distal end of the first dielectric block 110 (e.g., a top surface of the filter 100) may include an input/output (I/O) coupling 116 such as a port or an input loading interface (e.g., loop or probe input coupling). The I/O coupling 116 may be grounded. Moreover, the I/O coupling 116 may be created on the first dielectric block 110 by a laser. The I/O coupling 116 may facilitate receiving a radio frequency signal from an input and/or transmitting the radio frequency signal to the filter 100. A second distal end of the first dielectric block 110 (e.g., a top surface of the filter 100) may include an I/O coupling 120 such as an output loading interface (e.g., loop or probe input coupling). The I/O coupling 120 may facilitate transmitting a radio frequency signal (e.g., to another device) from the filter 100. First dielectric block 110 may include one or more apertures 117. For example, one or more of the ports (e.g., I/O coupling 116 or I/O coupling 118) may pass through one or more of the apertures 117.

The second dielectric block 130 may include a mating block pattern 132. For example, the mating block pattern 132 may correspond with a pattern of the first dielectric block 110 (e.g., resonator windows 112, inter-resonator coupling septum or septa 114, I/O coupling 116 and/or I/O coupling 118). Moreover, second dielectric block 130 may include one or more apertures 134, e.g., corresponding with apertures 117 of first dielectric block 110. When coupled, blocks may define resonator segments throughout the coupled blocks, where the characteristics of the resonator segments (e.g., resonant frequency, etc.) may be defined by the positioning, size, and shapes of the resonator windows 112 and inter-resonator coupling septum or septa 114. Additionally, resonator windows 112 may be defined between blocks.

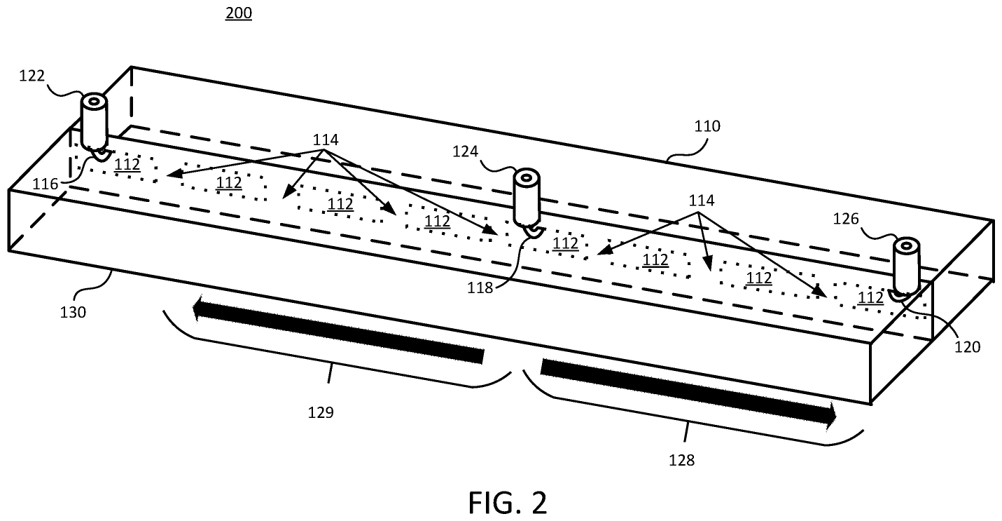

FIG. 2 depicts a duplexer/diplexer 200 according to the present disclosure. For example, the duplexer/diplexer 200 may comprise two dielectric blocks and may be a three-port device. For example, the duplexer/diplexer 200 may include a first dielectric block 110 (e.g., a ceramic block) coupled to a second dielectric block 130 (e.g., a ceramic block). The duplex/diplexer 200 may have a transmission (TX) side 129 and a reception (RX) side 128.

One or more surfaces of the blocks (e.g., first dielectric block 110 and/or second dielectric block 130) of the duplexer/diplexer 200 may be etched to form various structures contained in the duplexer/diplexer 200. Patterns may be printed on one or more adjoining block surfaces to create various coupling structures (e.g., resonator windows 112, inter-resonator coupling septa 114, ports, etc.) of the duplexer/diplexer 200. Moreover, the first dielectric block 110 may include a first coupling structure and the second dielectric block 130 may include a second coupling structure. According to some aspects, the plurality of septa 114 may include a first septum and a second septum and may be formed by the union of the first coupling structure and the second coupling structure. One or both of the first dielectric block 110 and the second dielectric block 130 may be comprised of ceramic.

For example, the first dielectric block 110 may include a first longitudinal surface comprising the first coupling structure, a second longitudinal surface, and a top surface. The second dielectric block 130 (e.g., a ceramic block) may include a second longitudinal surface comprising a second coupling structure, a second longitudinal surface, and a top surface, and may be coupled to the first dielectric block 110 via respective first and second longitudinal surfaces. Moreover, the first coupling structure may include a metallic coating disposed along an exterior of the first dielectric block 110 and the second coupling structure may include a metallic coating disposed along an exterior of the second dielectric block 130. For example, the first dielectric block 110 and/or second dielectric block 130 may be coated with a metallic substance prior to coupling to the other blocks of the duplexer/diplexer 200.

A plurality of resonator windows 112 may be defined by the first dielectric block 110 and the second dielectric block 130. A first window of the plurality of resonator windows 112 may be further defined by a first septum and a second septum of the plurality of septa 114. Moreover, the first dielectric block 110 and/or the second dielectric block 130 may comprise a four-pole filter (e.g., E-plane ceramic waveguide filter 100).

In some aspects, the I/O coupling 116 may comprise a loop (e.g., an inductive loop) on the TX side 129 and in communication with the first window of the plurality of resonator windows 112 and may be configured to transmit (e.g., based on a width of the septa 114) energy from the I/O coupling 116 to the first window of the plurality of resonator windows 112. The energy may be a radio frequency (RF) signal. The loop may be an inductive loop and may provide input loading into the RF filter (e.g., filter 100) of the duplexer/diplexer 200.

The I/O coupling 116 may be coupled to an I/O connector 122. For example, the I/O connector 122 may be an RF connector meant to supply a transmission line to the I/O coupling 116. Because an impedance mismatch in the duplexer/diplexer 200 may negatively affect the electrical performance of the duplexer/diplexer 200, an impedance (e.g., 50 ohms) of the I/O connector 122 may match the impedance of the I/O coupling 116.

The I/O coupling 118 of the duplexer/diplexer 200 may be configured to receive (e.g., based on a width of the septa 114) the transmitted energy from a first distal end of the waveguide duplexer/diplexer 200. For example, the width of the septa 114 may control an amount of energy coming from a transmission side of the duplexer/diplexer 200 by acting as the input loading from an antenna port to the transmission side of the duplexer/diplexer 200.

The I/O coupling 118 may be coupled to an I/O connector 124. For example, the I/O connector 124 may be an RF connector meant to supply an antenna line to the I/O coupling 118. Because an impedance mismatch in the duplexer/diplexer 200 may negatively affect the electrical performance of the duplexer/diplexer 200, an impedance (e.g., 50 ohms) of the I/O connector 124 may match the impedance of the I/O coupling 118.

An I/O coupling 120 on the RX side 128 of the duplexer/diplexer 200 may be configured to receive (e.g., based on the width of the septa 114) the transmitted energy at a second distal end of the duplexer/diplexer 200. The I/O coupling 120 may be coupled to an I/O connector 126. For example, the I/O connector 126 may be an RF connector for receiving energy from the RX side 128 of the duplexer/diplexer 200. Because an impedance mismatch in the duplexer/diplexer 200 may negatively affect the electrical performance of the duplexer/diplexer 200, an impedance (e.g., 50 ohms) of the I/O connector 126 may match the impedance of the I/O coupling 120.

According to some aspects, a width of the first septum may be equal to a width of the second septum. In some other aspects, a width of the first septum may be different from a width of the second septum. The first septum and/or the second septum may limit a residual field strength from the loop (e.g., inductive loop) to couple small amounts of energy from the first filter to the second filter (e.g., creating the duplexer/diplexer 200). The width of the first septum and/or the second septum may determine the input loading from a first channel of the duplexer/diplexer 200 to a second channel of the duplexer/diplexer 200.

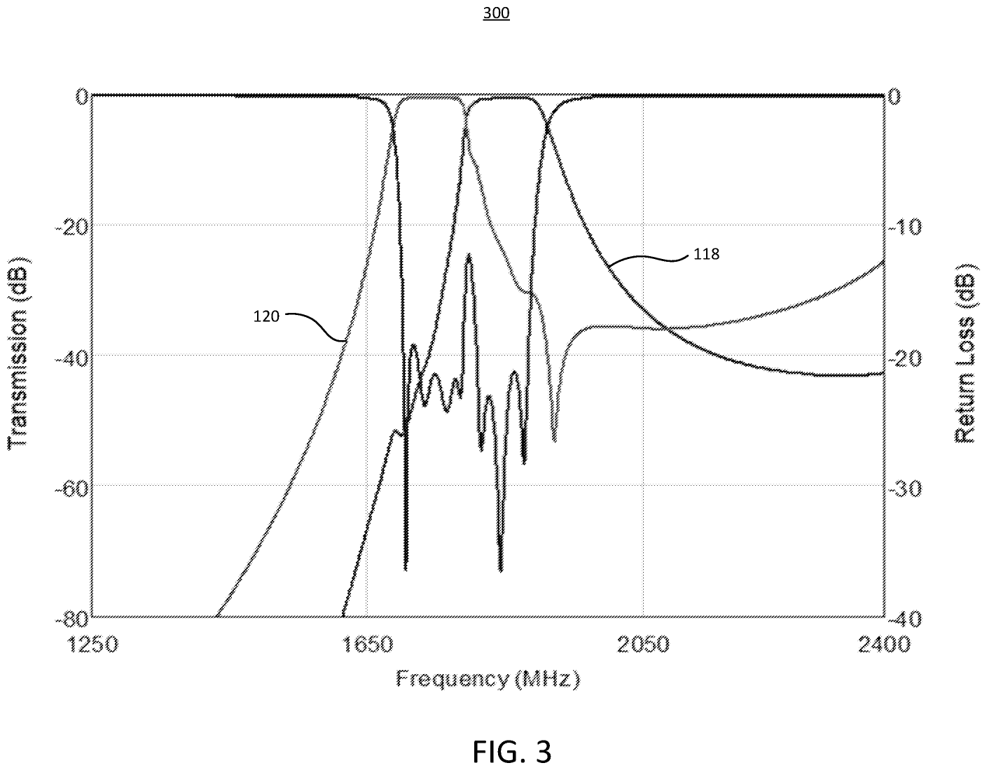

FIG. 3 depicts a frequency response graph 300 for a duplexer (e.g., duplexer/diplexer 200 comprising two of filter 100 connected in parallel) according to the present disclosure. The frequency response graph 300 may be associated with a performance of the duplexer/diplexer 200 depicted in FIG. 2. Frequency response graph 300 shows 2-transmission responses for the TX and RX duplex channels with two passbands. Frequency response graph 300 also shows the return loss at an antenna port (e.g., I/O coupling 118) comprising two dips with 4 smaller dips within the major dips. Moreover, each channel rejects signal power from the other channel.

According to some aspects, a frequency of an RF signal transmitted by the duplexer may be greater than a minimum transmission frequency (e.g., 1600 MHZ) and less than a maximum transmission frequency (e.g., 2000 MHz).

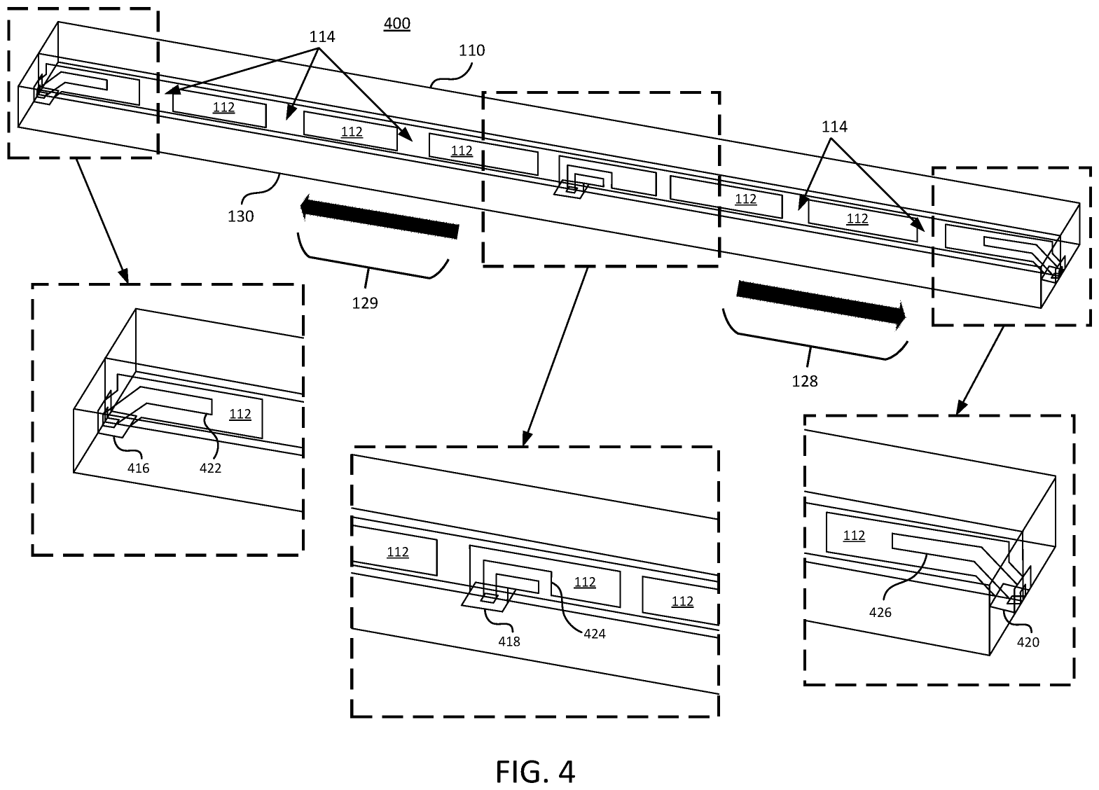

FIG. 4 depicts a duplexer/diplexer 400 according to the present disclosure. For example, the duplexer/diplexer 400 may comprise two dielectric blocks and may be a three-port device. For example, the duplexer/diplexer 400 may include a first dielectric block 110 (e.g., a ceramic block) coupled to a second dielectric block 130 (e.g., a ceramic block). The duplexer/diplexer 400 may have a transmission (TX) side 129 and a reception (RX) side 128.

One or more surfaces of the blocks (e.g., first dielectric block 110 and/or second dielectric block 130) of the duplexer/diplexer 400 may be etched to form various structures contained in the duplexer/diplexer 400. Patterns may be printed on one or more adjoining block surfaces to create various coupling structures (e.g., resonator windows 112, inter-resonator coupling septa 114, ports, etc.) of the duplexer/diplexer 400. Moreover, the first dielectric block 110 may include a first coupling structure and the second dielectric block 130 may include a second coupling structure. According to some aspects, the plurality of septa 114 may include a first septum and a second septum and may be formed by the union of the first coupling structure and the second coupling structure. One or both of the first dielectric block 110 and the second dielectric block 130 may be comprised of ceramic.

For example, the first dielectric block 110 may include a first longitudinal surface comprising the first coupling structure, a second longitudinal surface, and a top surface. The second dielectric block 130 (e.g., a ceramic block) may include a second longitudinal surface comprising a second coupling structure, a second longitudinal surface, and a top surface, and may be coupled to the first dielectric block 110 via respective first and second longitudinal surfaces. Moreover, the first coupling structure may include a metallic coating disposed along an exterior of the first dielectric block 110 and the second coupling structure may include a metallic coating disposed along an exterior of the second dielectric block 130. For example, the first dielectric block 110 and/or second dielectric block 130 may be coated with a metallic substance prior to coupling to the other blocks of the duplexer/diplexer 400.

A plurality of resonator windows 112 may be defined by the first dielectric block 110 and the second dielectric block 130. A first window of the plurality of resonator windows 112 may be further defined by a first septum and a second septum of the plurality of septa 114. Moreover, the first dielectric block 110 and/or the second dielectric block 130 may comprise a four-pole filter (e.g., E-plane ceramic waveguide filter 100).

I/O coupling 416 may comprise a surface mount I/O interface on the TX side 129 which may be in electrical connection with a capacitive I/O launch 422 (e.g., a capacitive input coupling probe). For example, the I/O coupling 416 and capacitive I/O launch 422 may be formed by corresponding mating surfaces of the first dielectric block 110 and second dielectric block 130. The I/O coupling 416 may be in communication with the first window of the plurality of resonator windows 112 and may be configured to transmit (e.g., based on a width of the septa 114) energy from the I/O coupling 116 to the first window of the plurality of resonator windows 112. The energy may be a radio frequency (RF) signal. The I/O coupling 416 and may provide input loading into the RF filter (e.g., filter 100) of the duplexer/diplexer 400.

I/O coupling 418 of the duplexer/diplexer 400 may be configured to receive (e.g., based on a width of the septa 114) the transmitted energy from a first distal end of the waveguide duplexer/diplexer 400. The I/O coupling 418 may comprise a surface mount I/O interface which may be in electrical connection with an inductive I/O launch 424 (e.g., an inductive input coupling probe). For example, the I/O coupling 418 and inductive I/O launch 424 may be formed by corresponding mating surfaces of the first dielectric block 110 and second dielectric block 130.

I/O coupling 420 on the RX side 128 of the duplexer/diplexer 400 may be configured to receive (e.g., based on the width of the septa 114) the transmitted energy at a second distal end of the duplexer/diplexer 400. The I/O coupling 420 may comprise a surface mount I/O interface which may be in electrical connection with a capacitive I/O launch 426. For example, the I/O coupling 420 and capacitive I/O launch 426 may be formed by corresponding mating surfaces of the first dielectric block 110 and second dielectric block 130.

According to some aspects, a width of the first septum may be equal to a width of the second septum. In some other aspects, a width of the first septum may be different from a width of the second septum. The first septum and/or the second septum may limit a residual field strength to couple small amounts of energy from the first filter to the second filter (e.g., creating the duplexer/diplexer 400). The width of the first septum and/or the second septum may determine the input loading from a first channel of the duplexer/diplexer 400 to a second channel of the duplexer/diplexer 400.

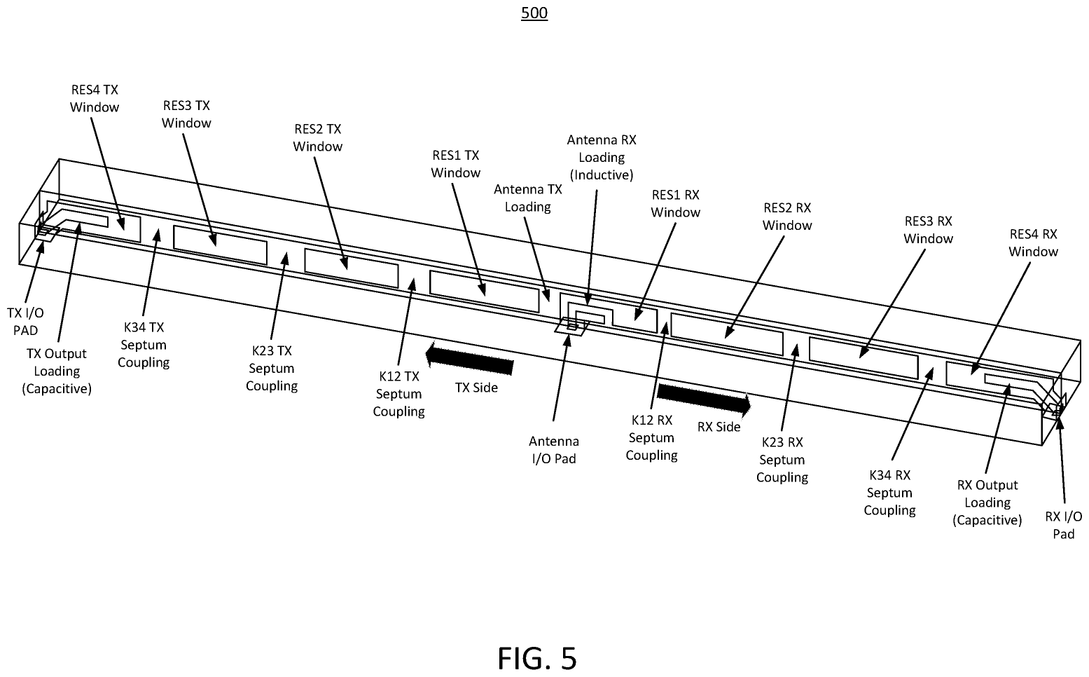

FIG. 5 depicts a duplexer/diplexer 500 according to the present disclosure. For example, the duplexer/diplexer 500 may comprise two coupled dielectric blocks and may be a three-port device. The duplexer/diplexer 500 may have a TX side 129 and an RX side 128.

One or more surfaces of the blocks of the duplexer/diplexer 500 may be etched to form various structures contained in the duplexer/diplexer 500. Patterns may be printed on one or more adjoining block surfaces to create various coupling structures of the duplexer/diplexer 500. According to some aspects the duplexer/diplexer 500 may comprise a plurality of loading interfaces, windows, septum couplings, and I/O pads.

For example, duplexer/diplexer 500 may comprise an Antenna I/O Pad between the TX side and the RX side. The Antenna I/O Pad may be coupled to an Antenna RX Loading (e.g., inductive) interface.

On the TX Side, an Antenna TX Loading septum may separate an RES1 RX Window and an RES1 TX Window. The Antenna TX Loading septum may act as an input loading from the Antenna RX Loading port to the TX side of the duplexer/diplexer 500. The antenna loop may radiate energy in a semi-circle. The width of the Antenna TX Loading septum may be selected to control the amount of energy going into the TX side of the duplexer/diplexer 500. Accordingly, Antenna TX Loading septum may act as the input loading from the Antenna RX Loading port to the TX side of the duplexer. A K12 TX Septum Coupling may separate the RES1 TX Window and an RES2 TX Window, a K23 TX Septum Coupling may separate the RES2 TX Window and an RES3 TX Window, and a K34 TX Septum Coupling may separate the RES3 TX Window and an RES4 TX Window. A TX I/O Pad may be coupled to a TX Output Loading (e.g., capacitive) interface.

On the RX Side, a K12 RX Septum Coupling may separate an RES1 RX Window and an RES2 RX Window. a K23 RX Septum Coupling may separate the RES2 RX Window and an RES3 RX Window, and a K34 RX Septum Coupling may separate the RES3 RX Window and an RES4 RX Window. An RX I/O Pad may be coupled to an RX Output Loading (e.g., capacitive) interface.

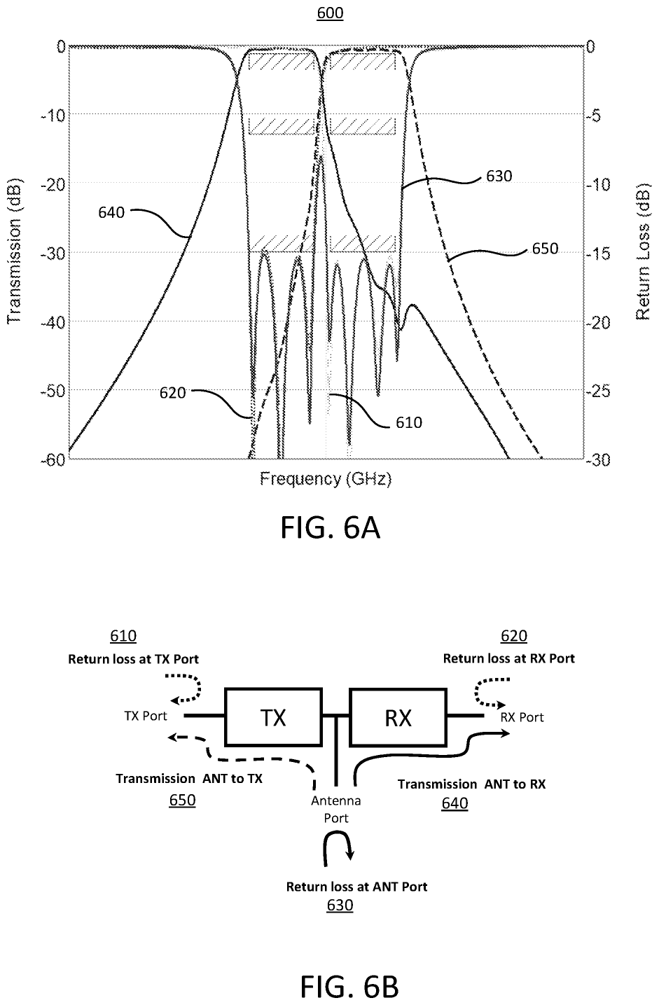

FIG. 6A illustrates a frequency response graph for duplexer/diplexer 500 and FIG. 6B illustrates a graph representation of duplexer/diplexer 500. More specifically, FIGS. 6A and 6B illustrate a return loss at the Antenna TX Loading port, a transmission from the antenna to the TX side, a transmission from the antenna to the RX side, a return loss at the TX output loading port, and a return loss at the RX output loading port.

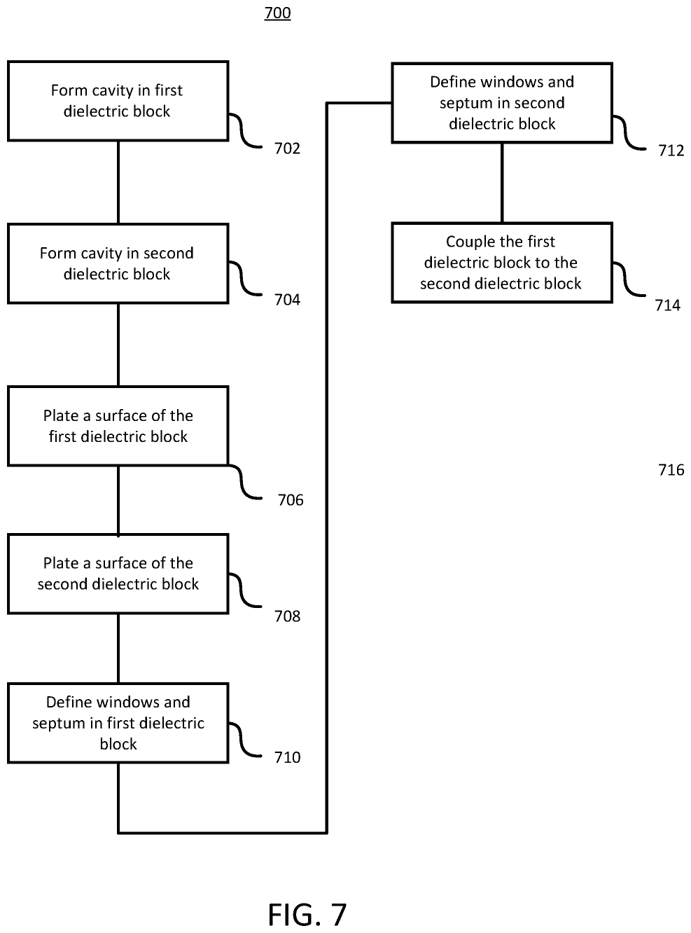

FIG. 7 depicts a process 700 for manufacturing a duplexer according to the present disclosure. The duplexer may be an example of the duplexer of FIGS. 1-2 and/or FIGS. 4-5. For example, the duplexer may include a common antenna port where the energy flow into TX and RX antenna junctions is controlled separately (e.g., to get the return loss to work properly).

At step 702, one or more recesses or cavities may be formed in a first dielectric block. For example, the one or more recesses or cavities (e.g., windows) may be formed on or in a longitudinal surface of the first dielectric block. The one or more recesses or cavities may form at least a part of one or more resonators. For example, a window may be formed by removing a portion of metal plating on a surface of the dielectric block, resulting in a recess having a depth based on the thickness of the metal plating (e.g., 0.00065″ in depth).

The first dielectric block may be an example of first dielectric block 110. A recess or cavity may span the width of the first dielectric block. Moreover, a width and a depth of the recess or cavity may vary. The recess or cavity may be generated, for example, by lasing the top (or other) surface of the first dielectric block.

At step 704, one or more recesses or cavities may be formed in a second dielectric block. The one or more recesses or cavities may form at least a part of one or more resonators. For example, the one or more recesses or cavities may be formed on or in a longitudinal surface of the second dielectric block. The second dielectric block may be an example of second dielectric block 130, second dielectric block 630, second dielectric block 730, and/or second dielectric block 930. A recess or cavity may span the width of the second dielectric block. Moreover, a width and a depth of the recess or cavity may vary. The recess or cavity may be generated, for example, by lasing the top (or other) surface of the second dielectric block.

At step 706, a surface the first dielectric block may be plated. For example, a longitudinal surface of the first dielectric block (e.g., including one or more recesses or cavities) may be plated with a metallic coating.

At step 708, a surface the second dielectric block may be plated. For example, a longitudinal surface of the second dielectric block (e.g., including one or more recesses or cavities) may be plated with a metallic coating.

At step 710, windows and septum may be defined on a metalized surface of the first dielectric block. For example, one or more of resonators, a metalized septum for inter-resonator couplings, and/or various input and output couplings loops or probes for input loading into the filter may be pressed, machined, lased, or screen printed onto\into the blocks, e.g., eliminating the need for a separate septum. According to some aspects, the number, size, and shapes of the windows and septum can vary.

At step 712, windows and septum may be defined on a metalized surface of the second dielectric block. For example, one or more of resonators, a metalized septum for inter-resonator couplings, and/or various input and output couplings loops or probes for input loading into the filter may be pressed, machined, lased, or screen printed onto\into the blocks, e.g., eliminating the need for a separate septum. According to some aspects, the number, size, and shapes of the windows and septum can vary.

At step 714, an RF E-plane waveguide filter may be formed by coupling the first dielectric block to the second dielectric block. For example, a coupling structure associated with the first dielectric block may be attached to a coupling structure associated with the second dielectric block). A septum may be formed by the union of the first coupling structure and the second coupling structure. For example, the coupling may occur by positioning a respective longitudinal surface of the first dielectric block to be flush with a respective longitudinal surface of the second dielectric block. In some cases, the first dielectric block may be coupled to the second dielectric block \via adhesive, compression, and the like. The windows may create a rectangular waveguide when the two blocks are attached together, where the length of each window determines at what frequency a waveguide section resonates. The septa between two waveguide windows creates the coupling between two resonators that shape the filter passband response.

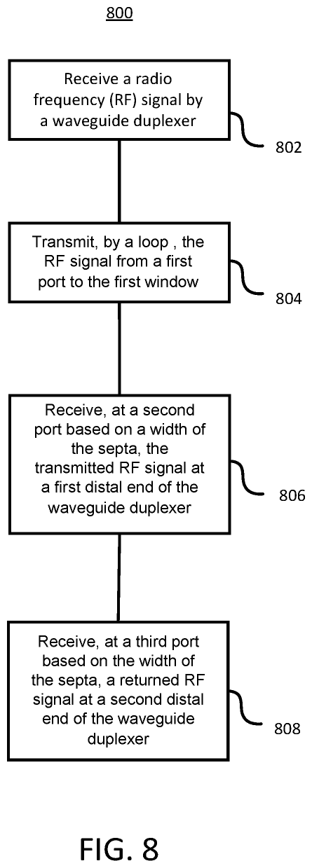

FIG. 8 depicts a process 800 for minimizing return loss of a transmission of an RF signal according to the present disclosure. At step 802, an RF signal may be received by a waveguide duplexer. The waveguide duplexer may include a plurality of septa formed by a union of a first dielectric block (e.g., including a 4-pole filter) and a second dielectric block (e.g., including a 4-pole filter). The plurality of septa may include a first septum and a second septum. Moreover, a plurality of windows may be defined by the first dielectric block and the second dielectric block. For example, a first window of the plurality of windows may be further defined by the first septum and the second septum.

At step 804, the RF signal may be transmitted by a loop from a first port to the first window. For example, the loop may be an inductive loop in communication with the first window. The transmitted RF signal may be received at a first distal end of the waveguide duplexer. For example, the transmitted RF signal may be received at a second port based on a width of the septa.

At step 806, a returned RF signal may be received at a second distal end of the E-plane waveguide duplexer. At step 808, the returned RF signal may be received at a third port based on the width of the septa. According to some aspects, a frequency of the transmitted RF signal may be greater than a minimum transmission frequency (e.g., 1600 MHZ) and less than a maximum transmission frequency (e.g., 2000 MHz).

While the figures herein describe particular examples of duplexers and E-plane waveguide filters, one skilled in the art will understand that the duplexers and E-plane waveguide filters described herein can vary based on particular dimensions and designs. For example, the number of windows included between dielectric blocks can vary, along with the particular size and shapes of the windows. Further, while the windows and septum are depicted on particular longitudinal surfaces, other longitudinal surfaces can also include windows and septum. For example, the windows and septum depicted on a particular surface may be additionally or alternatively be defined by the corresponding, adjacent surface of the corresponding, adjacent dielectric block. Similarly, the location of the input and output can vary as well, and can be placed in different positions along the surfaces of the filter. In some cases, additional dielectric blocks can be added to the filter as well, such that the filter contains six blocks, eight blocks, and the like.

While the system and method have been described in terms of what are presently considered to be specific embodiments, the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed:

1. A waveguide duplexer comprising:
a plurality of septa formed by a union of a first dielectric block and a second dielectric block, the plurality of septa comprising a first septum and a second septum;
a plurality of windows defined by the first dielectric block and the second dielectric block, wherein a first window of the plurality of windows is further defined by the first septum and the second septum;
a loop in communication with the first window and configured to transmit energy from a first port to the first window;
a second port configured to receive, based on a width of the septa, the transmitted energy at a first distal end of the waveguide duplexer; and
a third port configured to receive, based on the width of the septa, the transmitted energy at a second distal end of the waveguide duplexer.

2. The waveguide duplexer of claim 1, wherein the first septum is defined by a first width, the second septum is defined by a second width, and an input loading of the waveguide duplexer is based on the second width.

3. The waveguide duplexer of claim 1, wherein the loop is an inductive loop.

4. The waveguide duplexer of claim 1, wherein the first dielectric block comprises a first 4-pole filter and the second dielectric block comprises a second 4-pole filter.

5. The waveguide duplexer of claim 1, wherein a width of the first septum is equal to a width of the second septum.

6. The waveguide duplexer of claim 1, wherein a width of the first septum is different from a width of the second septum.

7. The waveguide duplexer of claim 1, wherein the first dielectric block comprises a first coupling structure and the second dielectric block comprises a second coupling structure, and the plurality of septa are formed by the union of the first coupling structure and the second coupling structure.

8. The waveguide duplexer of claim 2, wherein
the first dielectric block comprises a first longitudinal surface comprising the first coupling structure, a second longitudinal surface, and a top surface, and
the second dielectric block comprises a first longitudinal surface comprising the second coupling structure, a second longitudinal surface, and a top surface, and is coupled to the first dielectric block via respective first longitudinal surfaces.

9. The waveguide duplexer of claim 2, wherein the first coupling structure comprises a metallic coating disposed along an exterior of the first dielectric block and the second coupling structure comprises a metallic coating disposed along an exterior of the second dielectric block.

10. The waveguide duplexer of claim 1, wherein the transmitted energy is a radio frequency signal.

11. The waveguide duplexer of claim 1, wherein the first dielectric block comprises a ceramic and the second dielectric block comprises a ceramic.

12. The waveguide duplexer of claim 1, wherein the waveguide duplexer comprises an E-plane filter.

13. A method of minimizing return loss of a transmission of a radio frequency (RF) signal, the method comprising:
receiving an RF signal by a waveguide duplexer comprising a plurality of septa formed by a union of a first dielectric block and a second dielectric block, the plurality of septa comprising a first septum and a second septum, a plurality of windows defined by the first dielectric block and the second dielectric block, wherein a first window of the plurality of windows is further defined by the first septum and the second septum;
transmitting, by a loop, the RF signal from a first port to the first window;
receiving, at a second port based on a width of the septa, the transmitted RF signal at a first distal end of the waveguide duplexer; and
receiving, at a third port based on the width of the septa, a returned RF signal at a second distal end of the waveguide duplexer.

14. The method of claim 13, wherein the loop is an inductive loop in communication with the first window.

15. The method of claim 13, wherein the loop is a capacitive probe in communication with the first window.

16. The method of claim 13, wherein a frequency of the transmitted RF signal is greater than a minimum transmission frequency and less than a maximum transmission frequency.

17. The method of claim 13, wherein the first dielectric block comprises a first 4-pole filter and the second dielectric block comprises a second 4-pole filter.

18. A communication system comprising:
a printed circuit board comprising input pads, first output pads, and second output pads; and
a waveguide duplexer comprising:
a plurality of septa formed by a union of a first dielectric block and a second dielectric block, the plurality of septa comprising a first septum and a second septum;
a plurality of windows defined by the first dielectric block and the second dielectric block, wherein a first window of the plurality of windows is further defined by the first septum and the second septum; and
an inductive loop configured to transmit energy from the input pads to the first window, wherein
the first output pads are configured to receive, based on a width of the septa, the transmitted energy at a first distal end of the waveguide duplexer and
the second output pads are configured to receive, based on the width of the septa, the transmitted energy at a second distal end of the waveguide duplexer.

19. The communication system of claim 18, wherein a width of the first septum is equal to a width of the second septum.

20. The communication system of claim 18, wherein a width of the first septum is different from a width of the second septum.
